(19) United States
(12) Patent Application Publication
(10) Pub. No.: US 2014/0177270 A1
(43) Pub. Date: Jun. 26, 2014

(54) BACKLIGHT MODULE

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/014,419

(22) Filed: Aug. 30, 2013

(30) Foreign Application Priority Data
Dec. 25, 2012 (TW) 101149872

(51) Int. Cl. F21V 8/00

(52) U.S. Cl. CPC G02B 6/0088
USPC 362/607; 362/97.1

(57) ABSTRACT

A backlight module includes LEDs; a light guiding plate receiving light emitted from the LEDs; a diffusion sheet arranged above the light guiding plate; and a lens arranged above on the diffusion sheet. The lens comprises a light incident surface facing the diffusion sheet, and the light incident surface has a plurality of prism protrusions formed thereon. Each prism protrusion has a cross section of an inverted triangle with a bottom vertex having an internal angle of 50-57 degrees.

### BACKGROUND

1. Technical Field

The disclosure generally relates to backlight modules, and particularly to a backlight module with a simple structure, a low cost and a low profile.

2. Description of Related Art

A typical LCD device includes a liquid crystal display panel, and a backlight module mounted behind the liquid crystal display panel. The backlight module mainly includes a light source and a light guiding plate. The light guiding plate is generally made of a transparent acrylic plastic, and is used for guiding the light beams emitted by the light source.

An LED edge type backlight module includes a light guiding plate and an LED light source. Referring to FIG. 1, light emitted from LED travels through the light guiding plate and has a radiation angle ranged from 60 degrees to 90 degrees such that the visual angle is deviated from the normal direction. Referring to FIG. 2, a diffusion sheet is arranged on a front surface of the light guiding plate to adjust the radiation angle of the backlight module. Light emitted from LED travels through the guiding plate and the diffusion sheet, and has a radiation angle ranged from 30 degrees to 60 degrees. However, the front visual angle of the backlight module is still unfavorable since the light is mostly concentrated within the angle ranged from 30 degrees to 60 degrees, which is still deviated from the normal direction. To enable the light from the light guiding plate to be directed to the normal direction, a lower BEF (brightness enhanced film) and a lower BEF (brightness enhanced film) are positioned over the diffusion sheet. The incorporation of the upper and lower BEFs not only increases the cost but also complicates the structure. Furthermore, a thickness of the backlight module is large.

Therefore, what is needed is a backlight module which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present light emitting diode device for microminiaturization. Moreover, in the drawing, like reference numerals designate corresponding parts throughout the whole view.

FIG. 1 is a distribution graph of a radiation angle of a backlight module without a diffusion sheet in related art.

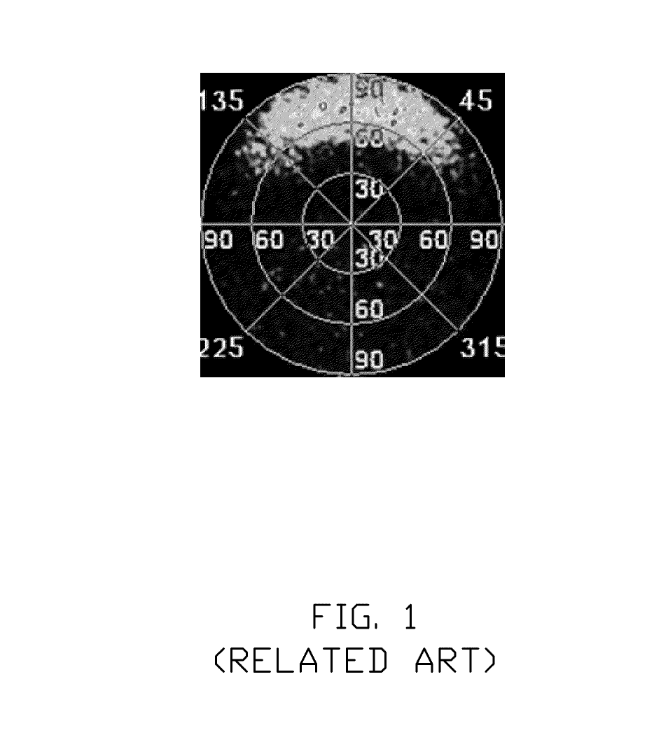

FIG. 2 is a distribution graph of a radiation angle of a backlight module with a diffusion sheet in related art.

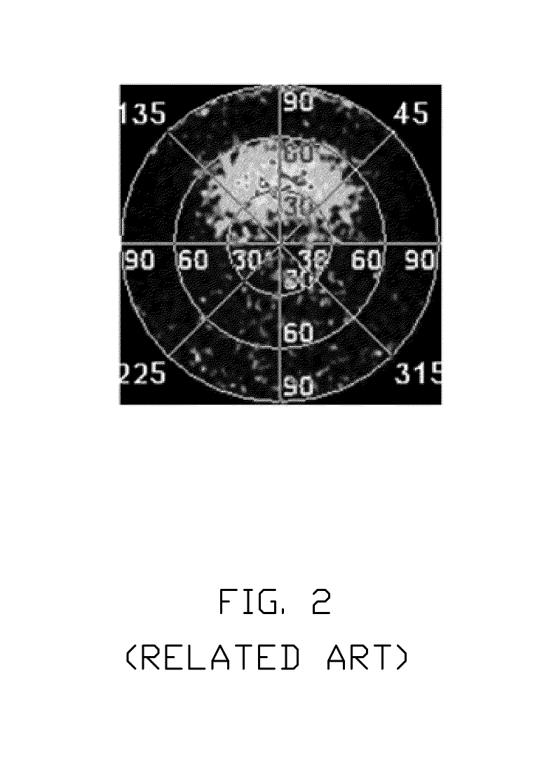

FIG. 3 is a cross-sectional view of a backlight module in accordance with an exemplary embodiment of the present disclosure.

FIG. 4 is a distribution graph of radiation of the backlight module of FIG. 3 when an internal angle of a prism protrusion of the backlight module is 50 degrees.

FIG. 5 is a distribution graph of a radiation angle of the backlight module of FIG. 3 when an internal angle of the prism protrusion is 55 degrees.

FIG. 6 is a distribution graph of a radiation angle of the backlight module of FIG. 3 when an internal angle of the prism protrusion is 57 degrees.

### DETAILED DESCRIPTION OF EMBODIMENTS

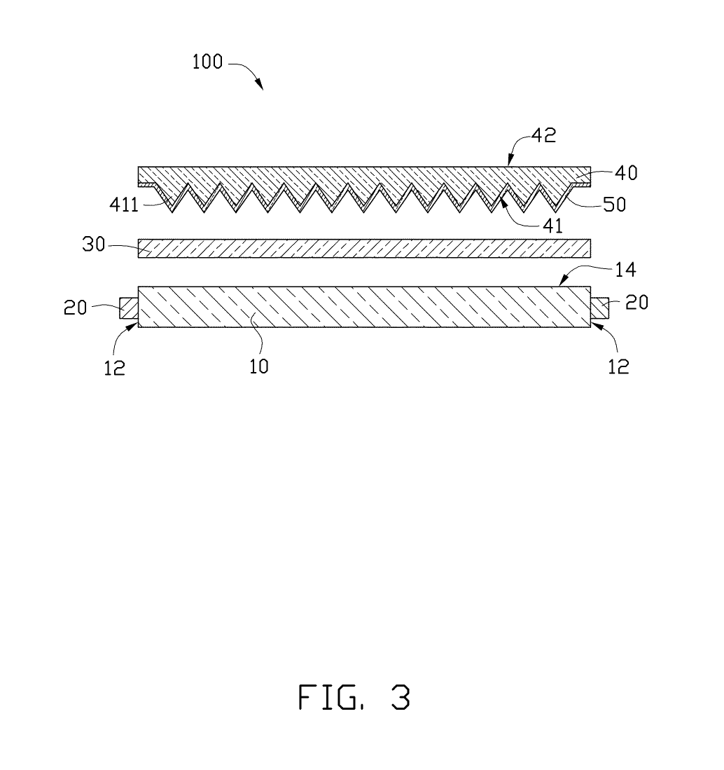

Referring to FIG. 3, a backlight module 100 in accordance with an exemplary embodiment is shown. In the present embodiment, the backlight module 100 is an edge type backlight module. The backlight module 100 includes a light guiding plate 10, two LEDs 20 arranged on two sidewalls of the light guiding plate 10, a diffusion sheet 30 arranged above the light guiding plate 10, and a lens 40 arranged above the diffusion sheet 30. The lens 40 has a plurality of inverted prisms arranged in a matrix on a bottom face of the lens 40.

The light guiding plate 10 can be made of a material with high light transmitting index selected from polymethyl methacrylate (PMMA) sheet, polycarbonate (PC) or other suitable materials. In the present embodiment, the light guiding plate 10 is rectangular, and includes two light input surfaces 12 respectively facing toward the LEDs 20, a light output surface 14 adjacent to and connected to the light input surfaces 12, and a bottom surface (not labeled) opposite to the light output surface 14. The light output surface 14 is a top surface of the light guiding plate 10. Light beams emitted from LEDs 20 pass through the light input surfaces 12 and enter the light guiding plate 10. A part of the light beams travels through the light output surface 14 of the light guiding plate 10 to an outside for lightening directly, and the other part of the light beams is reflected by the bottom surface and then travels through the light output surface 14 of the light guiding plate 10 to the outside for lightening. A reflective layer (not shown) or a plurality of dots (not shown) can be arranged on the bottom surface to reflect light emitted from the LEDs 20. The reflective layer can be made of metal, such as silver, aluminum or aurum. The dots can be formed in various patterns, for example hemispherical, cylindrical, cubic, cuboid, or pyramidal.

The LEDs 20 face the light input surfaces 12 of the light guiding plate 10. In the present embodiment, the LEDs 20 are attached to the light input surfaces 12 via an adhesive layer.

The diffusion sheet 30 is located above the light guide plate 10 and is configured for uniformly diffusing the emitted light, thereby avoiding the occurrence of light spots on a display intended for illumination, and light output from the light guide plate 10 to the lens 40 is evenly distributed.

The lens 40 is arranged above the diffusion sheet 30. The lens 40 can be made of a material with high light transmitting index, such as polycarbonate (PC). The lens 40 includes a light incident surface 41 facing the diffusion sheet 30 and a light emitting surface 42 opposite to the light incident surface 41. The light incident surface 41 has a plurality of prism protrusions 411 formed thereon, wherein each prism protrusion 41 has a cross section with a shape of an inverted triangle. The prism protrusions 411 are continuously connected together and cover substantially the whole light incident surface 41. A cross section of the prism protrusion 411 is inverted-triangular with a bottom vertex pointed perpendicularly to the diffusion sheet 30. An internal angle of the bottom vertex of the prism protrusion 411 is in the range from 50 to 57 degrees. The light emitting surface 42 of the lens 40 is planar. The lens 40 is used for changing the direction of light which transmits from the diffusion sheet 30 to a desired visual direction, i.e. normal direction.

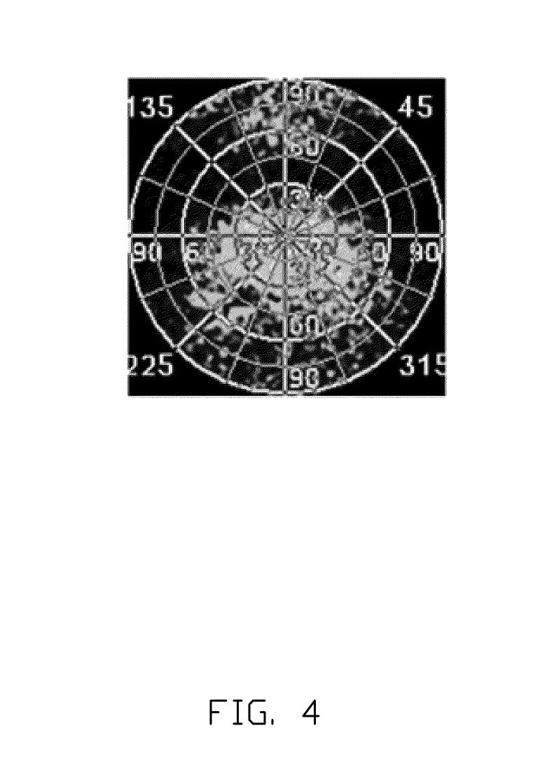

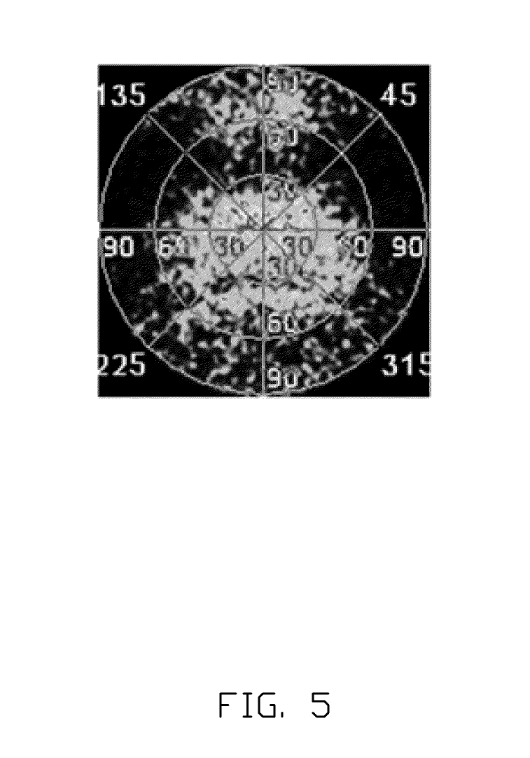

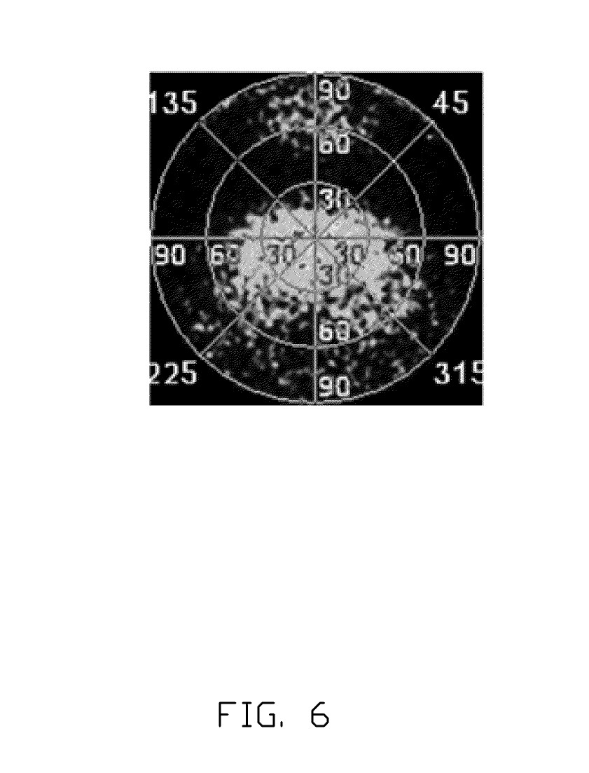

Referring to FIG. 4, a distribution graph of a radiation angle of the backlight module 100 is shown, wherein an internal angle of the prism is 50 degrees, and the radiation angle of the light emitted from LEDs 20 is concentrated in the range from 0 to 60 degrees. Referring to FIG. 5, another distribution graph of radiation angle of the backlight module 100 is shown, wherein an internal angle of the prism is 55 degrees, and the radiation angle of the light emitted from LEDs 20 is concentrated in the range from 0 to 60 degrees. FIG. 6 shows still another distribution graph of a radiation angle of the backlight module 100 when an internal angle of the prism is 57 degrees, and the radiation angle of the light emitted from LEDs 20 is concentrated in the range from 0 to 60 degrees. When the internal angle of the prism is 57 degrees, light concentrated in the range from 0 to 30 degrees is much more than that when the internal angle of the prism is 50 degrees or 55 degrees.

In the present embodiment, the LEDs 20 are blue LEDs. A yellow fluorescent layer 50 is arranged on the light incident surface 41 of the lens 40. The blue light emitted from the LEDs 20 strikes yellow fluorescent layer 50 to generate a yellow secondary color light. The combination of the yellow secondary color light and residual blue light produces a white light. The light direction after being adjusted by the lens 40 is mainly located within 60 degrees (i.e., 0-60 degrees) whereby the light is mainly on the normal direction to the light emitting surface 42 of the lens 40; accordingly, the light can effectively illuminate an LCD (liquid crystal display) panel to enable the content of the LCD panel to be visible to a user who usually looks at the LCD panel by the normal direction. In an alternative embodiment, the yellow fluorescent layer 50 can be arranged on the light guiding plate 10 or the diffusion sheet 30, and the fluorescent layer can be red fluorescent layer and green fluorescent layer.

In an alternative embodiment, the backlight module can be a direct type backlight module. In this condition, the light guiding plate 10 is omitted and the light emitting surfaces of the LEDs 20 are located directly under the diffusion sheet 30 to emit light to the diffusion sheet 30.

In the present disclosure only a lens is needed to achieve the adjustment of direction of light from the diffusion sheet 30 to the normal direction, whereby the backlight module 100 in accordance with the present disclosure has a simple structure and a low cost. Furthermore, a total thickness of the backlight module 100 is decreased.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A backlight module comprising:
LEDs;
a light guiding plate receiving light emitted from the LEDs;
a diffusion sheet arranged above the light guiding plate; and
a lens arranged above on the diffusion sheet, the lens comprising a light incident surface facing the diffusion sheet, the light incident surface having a plurality of prism protrusions formed thereon, each prism protrusion having a cross section with a shape of an inverted triangle.

2. The backlight module of claim 1, wherein the prism protrusions are continuously connected together and cover the light incident surface.

3. The backlight module of claim 1, wherein a bottom vertex of each prism protrusion is perpendicularly pointed toward the diffusion sheet, an internal angle of the bottom vertex of each prism protrusion being in the range from 50 to 57 degrees.

4. The backlight module of claim 1, wherein the light guiding plate comprises two light input surfaces each facing at least an LED, and a light output surface adjacent to and connected to the light input surfaces and facing the diffusion sheet.

5. The backlight module of claim 4, wherein the light guiding plate further comprises a bottom surface opposite to the light output surface, a reflective layer being arranged on the bottom surface.

6. The backlight module of claim 4, wherein the light guiding plate further comprises a bottom surface opposite to the light output surface, a plurality of dots being arranged on the bottom surface.

7. The backlight module of claim 1, wherein the LEDs are blue LEDs, and a yellow fluorescent layer is arranged on the light incident surface of the lens.

8. A backlight module comprising:
a light guiding plate comprising two light input surfaces and a light output surface adjacent to and connected to the light input surfaces;
LEDs respectively facing the light input surfaces;
a diffusion sheet arranged above the light output surface of the light guiding plate; and
a lens arranged above on the diffusion sheet, the lens comprising a light incident surface facing the diffusion sheet, the light incident surface having a series of prism protrusions formed thereon, the prism protrusions each having a vertex pointed toward the diffusion sheet.

9. The backlight module of claim 8, wherein a cross section of each prism protrusion is inverted triangular, an internal angle of the vertex of each prism protrusion pointed toward the diffusion sheet being in the range from 50 to 57 degrees.

10. The backlight module of claim 8, wherein the light guiding plate further comprises a bottom surface opposite to the light output surface, a reflective layer being arranged on the bottom surface.

11. The backlight module of claim 8, wherein the light guiding plate further comprises a bottom surface opposite to the light output surface, a plurality of dots being arranged on the bottom surface.

12. The backlight module of claim 8, wherein the LEDs are blue LEDs, and a yellow fluorescent layer is arranged on the light incident surface of the lens.

13. A backlight module comprising:
LEDs;
a diffusion sheet arranged above light output surfaces of the LEDs; and
a lens arranged above on the diffusion sheet, the lens comprising a light incident surface facing the diffusion sheet, the light incident surface having a series of prism protrusions formed thereon, each prism protrusion having a cross section of an inverted triangle.

14. The backlight module of claim 13, wherein a bottom vertex of each prism protrusion is pointed perpendicularly toward the diffusion sheet and an internal angle of the bottom vertex of each prism protrusion is in the range from 50 to 57 degrees.
